(19) United States
(12) Patent Application Publication
(10) Pub. No.: US 2026/0099874 A1
(43) Pub. Date: Apr. 9, 2026

(54) Electronic Devices and Corresponding Methods for Precluding User Interaction Events in an Interactive Computing Environment

(71) Applicant: Motorola Mobility LLC, Chicago, IL (US)

(72) Inventors: Vijayprakash Idlur, Bangalore (IN); Prasad AG, Bangalore (IN); Krishnan Raghavan, Bangalore (IN)

(21) Appl. No.: 18/907,421

(22) Filed: Oct. 4, 2024

(51) Int. Cl. G06Q 30/0601

(52) U.S. Cl. CPC G06Q 30/0633; G06Q 30/0641

(57) ABSTRACT

An electronic device and method preclude user interaction events in an electronic shopping interactive computing environment. The method involves comparing a shopping cart interaction event to at least one previous user interaction event associated with the user. When a metric associated with the previous user interaction event deviates from a corresponding metric associated with the shopping cart interaction event, the method presents a prompt on a user interface indicating that additional shopping cart interaction events will be unavailable for product return user interaction events. The electronic device includes a user interface, memory, and processors that compare the price of an item with metrics associated with past purchases and returns. If the price exceeds predefined thresholds, the device precludes product return user interaction events, thereby mitigating potential return fraud.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. When used in conjunction with e-commerce sites, such devices make it incredibly simple to purchase goods and services with just a click or two.

At the same time, fraudulent returns remain a significant problem in e-commerce, with dishonest customers exploiting return policies to return used or mismatched items for refunds or exchanges, resulting in financial losses for retailers. It would be advantageous to have improved electronic devices, methods, and corresponding systems that alleviate this problem.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates another explanatory method in accordance with one or more embodiments of the disclosure.

FIG. 5 illustrates one explanatory electronic device in accordance with one or more embodiments of the disclosure.

FIG. 6 illustrates one explanatory electronic device in accordance with one or more embodiments of the disclosure.

FIG. 7 illustrates one or more embodiments of the disclosures.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to, in response to user input from a user initiating a shopping cart interaction event in an electronic shopping interactive computing environment operating on one or more processors of the electronic device, comparing, by the one or more processors, the shopping cart interaction event to at least one previous user interaction event associated with the user in the electronic shopping interactive computing environment and, where a metric associated with the at least one previous user interaction event deviates from a corresponding metric associated with the shopping cart interaction event, presenting, by the one or more processors, a prompt on a user interface of the electronic device indicating that any additional shopping cart interaction events will be unavailable for product return user interaction events in the electronic shopping interactive computing environment. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to the one or more processors detecting an item selection by a shopping cart interaction event made by a user in an interactive shopping session in an electronic shopping application operating on the one or more processors, the one or more processors compare a price of the item with at least a first metric associated with past purchases made by the user in the electronic shopping application and at least a second metric associated with past returns made by the user in the electronic shopping application. In one or more embodiments, when either the price exceeds the first metric by a predefined threshold or the price exceeds the second metric by a predefined threshold, the one or more processors preclude product return user interaction events from occurring in the electronic shopping application.

The non-processor circuits may include, but are not limited to, a radio receiver, a radio transmitter, signal drivers, clock circuits, power source circuits, and user input devices. As such, these functions may be interpreted as steps of a method to perform, in response to user input from a user initiating a shopping cart interaction event in an electronic shopping interactive computing environment operating on one or more processors of the electronic device, comparing, by the one or more processors a price of an item that is subject of the shopping cart interaction event to a first summary price of products ordered by the user, both overall and per a category associated with the item, a second summary price of products returned by the user, both overall and per the category, and a third summary price of products available in the electronic shopping interactive computing environment, both overall and per the category. In one or more embodiments, where the price exceeds any of the first summary price, the second summary price, or the third summary price, precluding product return user interaction events for the item from occurring in the electronic shopping interactive computing environment.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that fraudulent returns remain a significant problem in e-commerce, with dishonest customers exploiting return policies to return used or mismatched items for refunds or exchanges, resulting in financial losses for retailers. E-commerce companies face a challenge with users purchasing products for specific occasions, using them, and then returning them for a refund. This behavior undermines the profitability and trust of e-commerce platforms, necessitating the development of more effective fraud detection and prevention methods.

Current solutions to address fraudulent returns include tracking return patterns, identifying suspicious behavior, and employing sophisticated fraud detection tools to spot irregularities in return requests. These methods often involve customer identity verification, restocking fees, and limiting return windows. Additionally, clear return policies and thorough inspection of returned items help deter fraudulent activity. Collaborating with third-party fraud prevention services further enhances security. However, these measures are not entirely foolproof and may still allow some fraudulent returns to slip through, impacting retailers'profitability and the fairness of the shopping environment for honest customers.

Advantageously, embodiments of the disclosure address the issue of fraudulent returns by leveraging data analytics and pattern recognition to identify anomalies in purchase behavior. By comparing the price of a new order with the user's average purchase and return prices, the method can flag potential fraudulent returns. Advantageously, this approach allows for the implementation of preventive measures, such as converting the return option to an exchange-only policy or blocking the new order, thereby reducing the likelihood of return fraud and safeguarding the retailer's financial stability.

Embodiments of the disclosure provide electronic devices and methods for preventing potential return frauds by using average purchase price anomalies. Unlike traditional fraud detection methods that primarily rely on tracking return patterns and identifying suspicious behavior, embodiments of the disclosure leverage data analytics to compare the price of a new order with the user's historical purchase and return prices. By calculating the average price of products ordered and returned by the user, as well as the average price of products available in the entire shopping application, the system can identify significant deviations that may indicate fraudulent behavior.

Embodiments of the disclosure employ several unique steps, including recording the purchase price of each item ordered by the user, calculating average prices overall and per category, and using these averages to predict potential fraudulent returns. The system flags instances where the price of a new order significantly exceeds the user's average purchase price or closely matches the user's average return price. This approach allows for the implementation of preventive measures, such as converting the return option to an exchange-only policy or blocking the new order altogether.

Advantageously, this novel combination of data analytics, pattern recognition, and preventive measures provides a more accurate and effective way to detect and prevent return fraud. By focusing on average purchase price anomalies, the system can identify and address fraudulent behavior that may not be apparent through traditional methods. This proactive approach enhances the security and integrity of e-commerce platforms, reducing financial losses for retailers and maintaining a fair shopping environment for honest customers.

Embodiments of the disclosure contemplate that e-commerce companies face a significant challenge with users purchasing products for specific occasions, using them, and then returning them for a refund. This behavior, often referred to as “wardrobing,” undermines the profitability and trust of e-commerce platforms. Users exploit return policies by buying items for one-time use, such as for a party or event, and then returning them after use. This practice results in financial losses for retailers and disrupts the integrity of the return system.

Illustrating by example, consider a shopper named John. John's habitual purchases hovered around modestly priced items, far from the extravagant blazer he bought for the wedding. John audaciously returned the expensive garment after use, emboldening himself. Proudly sharing his exploit, John convinced friends to follow suit. This trend, purchasing significantly pricier items than their usual, only to return them post-use, posed a dire threat to the e-commerce company. The stark contrast between John's average spending and this pricey blazer signaled a disturbing pattern of abuse, jeopardizing the company's profitability and trust.

Measures like stringent return policies or advanced algorithms became necessary to counteract this detrimental trend before the trend further eroded the company's financial stability and reputation. Implementing measures like stricter return policies, restocking fees, or even suspending accounts displaying this behavior can help deter misuse of return systems.

Embodiments of the disclosure work differently than do these stringent “one size fits all” return policies. Instead of simply precluding returns all together, embodiments of the disclosure, in response to user input from a user initiating a shopping cart interaction event in an electronic shopping interactive computing environment operating on one or more processors of the electronic device, compare, using one or more processors, the shopping cart interaction event to at least one previous user interaction event associated with the user in the electronic shopping interactive computing environment. In one or more embodiments, where a metric associated with the at least one previous user interaction event deviates from a corresponding metric associated with the shopping cart interaction event, the one or more processors present a prompt on a user interface of the electronic device indicating that any additional shopping cart interaction events will be unavailable for product return user interaction events in the electronic shopping interactive computing environment.

By comparing the shopping cart interaction event to at least one previous user interaction event associated with the user, the method enables the detection of anomalies in purchasing behavior. This comparison allows the system to identify potentially fraudulent activities by analyzing deviations in metrics such as purchase prices. This proactive approach helps in flagging suspicious transactions before they are completed, thereby reducing the likelihood of fraudulent returns.

Presenting a prompt on the user interface indicating that additional shopping cart interaction events will be unavailable for product return user interaction events provides immediate feedback to the user. This not only deters fraudulent behavior but also informs the user of the restrictions being applied, enhancing transparency and user awareness. This method ensures that the user is aware of the consequences of their purchasing behavior, which can discourage attempts to exploit return policies.

The integration of this method into the electronic shopping interactive computing environment leverages the processing capabilities of the electronic device to perform real-time analysis and decision-making. This enhances the overall security and integrity of the e-commerce platform by preventing fraudulent returns, thereby safeguarding the retailer's financial stability and maintaining a fair shopping environment for honest customers.

In one or more embodiments, a method to reduce potential return frauds leverages average purchase price anomalies. In one or more embodiments, this method records the purchase price of each item ordered by a user, where the user is identified through various signals such as login information, device used, phone number, email address, delivery addresses, and Internet Protocol (IP) addresses. In one or more embodiments, the system calculates the average price of products ordered overall and per category for the user, as well as the average price of products returned overall and per category for the user. Additionally, the system can calculate the average price of products available in the entire shopping application overall and per category.

Using the recorded information, the system can predict potentially fraudulent returns when the user places a new order. In one or more embodiments, the method involves comparing the price of the item in the new order with the user's average purchase price of previously ordered items. If the price difference exceeds a predefined threshold, the system flags the transaction as potentially fraudulent.

In one or more embodiments, the method also compares the price of the new order with the user's average return price and the average prices of products in the shopping application. If the price closely matches the user's average return price or significantly deviates from the average prices in the shopping application, the system flags the transaction for further review.

Upon detecting a potentially fraudulent return, the system can implement preventive measures such as converting the return option to an exchange-only policy or blocking the new order from being made. This approach aims to deter misuse of return systems by identifying and addressing anomalies in purchase behavior, thereby safeguarding retailers'profitability and maintaining a fair shopping environment for honest customers.

In one or more embodiments, an electronic device comprises a user interface, a memory, and one or more processors operable with the user interface and the memory. In one or more embodiments, in response to the one or more processors detecting an item selection by a shopping cart interaction event made by a user in an interactive shopping session in an electronic shopping application operating on the one or more processors, the one or more processors compare a price of the item with at least a first metric associated with past purchases made by the user in the electronic shopping application and at least a second metric associated with past returns made by the user in the electronic shopping application.

In one or more embodiments, when either the price exceeds the first metric by a predefined threshold or the price exceeds the second metric by a predefined threshold, the one or more processors preclude product return user interaction events from occurring in the electronic shopping application. This preclusion aims to mitigate potential return fraud by identifying anomalies in the user's purchasing and returning behavior, thereby safeguarding the retailer's financial stability and maintaining a fair shopping environment for honest customers.

By comparing the price of an item selected during a shopping cart interaction event with at least a first metric associated with past purchases and a second metric associated with past returns, the electronic device can identify anomalies in purchasing behavior. This comparison allows the system to detect potentially fraudulent activities by analyzing deviations in metrics such as purchase and return prices. This proactive approach helps in flagging suspicious transactions before they are completed, thereby reducing the likelihood of fraudulent returns.

When the price of the item exceeds either the first metric by a predefined threshold or the second metric by a predefined threshold, the electronic device precludes product return user interaction events from occurring in the electronic shopping application. This preclusion aims to mitigate potential return fraud by identifying anomalies in the user's purchasing and returning behavior. The integration of this method into the electronic shopping interactive computing environment leverages the processing capabilities of the electronic device to perform real-time analysis and decision-making. This enhances the overall security and integrity of the e-commerce platform.

In one or more embodiments, a method in an electronic device comprises, in response to user input from a user initiating a shopping cart interaction event in an electronic shopping interactive computing environment operating on one or more processors of the electronic device, comparing, by the one or more processors, a price of an item that is subject of the shopping cart interaction event to a first summary price of products ordered by the user, both overall and per a category associated with the item, a second summary price of products returned by the user, both overall and per the category, and a third summary price of products available in the electronic shopping interactive computing environment, both overall and per the category. Where the price exceeds any of the first summary price, the second summary price, or the third summary price, the method precludes product return user interaction events for the item from occurring in the electronic shopping interactive computing environment.

By comparing the price of an item that is the subject of a shopping cart interaction event to a first summary price of products ordered by the user, both overall and per a category associated with the item, a second summary price of products returned by the user, both overall and per the category, and a third summary price of products available in the electronic shopping interactive computing environment, both overall and per the category, the method enables the detection of anomalies in purchasing behavior. This multi-faceted comparison allows the system to identify potentially fraudulent activities by analyzing deviations in metrics such as purchase and return prices, as well as the general market price for similar items.

Precluding product return user interaction events for the item when its price exceeds any of the first summary price, the second summary price, or the third summary price helps to mitigate potential return fraud. This approach leverages data analytics to flag suspicious transactions before they are completed, thereby reducing the likelihood of fraudulent returns. Other advantages offered by embodiments of the disclosure will be described below. Still others will be obvious to those of ordinary skill in the art having the benefit of this disclosure.

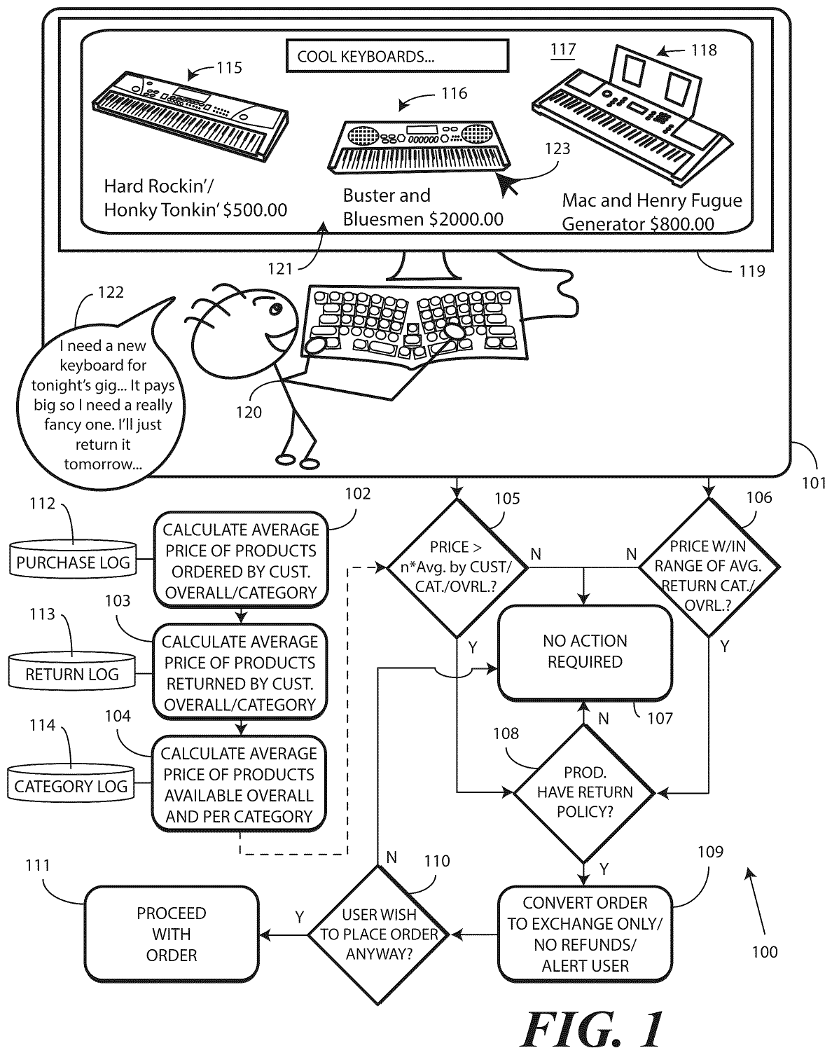

Turning now to FIG. 1, illustrated therein is one explanatory system 100 configured in accordance with one or more embodiments of the disclosure. The system 100 includes both electronic devices, one example of which is the computer shown at step 101, and various method steps for performing a method that, in response to user input from a user initiating a shopping cart interaction event in an electronic shopping interactive computing environment 117 operating on one or more processors of the electronic device, comparing, by the one or more processors, the shopping cart interaction event to at least one previous user interaction event associated with the user in the electronic shopping interactive computing environment. In one or more embodiments, where a metric associated with the at least one previous user interaction event deviates from a corresponding metric associated with the shopping cart interaction event, the method comprises presenting, by the one or more processors, a prompt on a user interface of the electronic device indicating that any additional shopping cart interaction events will be unavailable for product return user interaction events in the electronic shopping interactive computing environment.

As shown at step 103, a shopper 120 notorious for making returns after using products, is in the market for a musical keyboard. In this illustrative example, the shopper 120 needs not only a keyboard, but a really fancy one because, as the shopper exclaims 122, the gig “pays really big.” Accordingly, the shopper 120 has initiated an electronic shopping interactive computing environment 117 to find just the right keyboard.

In this illustration, initial options presented in response to the shopper's search string for “cool keyboards” include a “Hard Rockin'/Honkey Tonkin'” electric piano 115, which sells for $500, a Buster and His Bluesmen officially branded keyboard 116, which is super fancy and sells for $2000, and a Mac and Henry Fugue Generator keyboard 118, which is mid-range and sells for $800. Each keyboard has recommendations, reviews, different prices, different numbers of keys, different features, and different capabilities. The “Hard Rockin'/Honkey Tonkin'” electric piano 115 has “klanky” barroom sounds with built in speakers and a microphone. The Buster and His Bluesmen officially branded keyboard 116 is handmade, especially designed for “blues bliss,” and is even hand-signed by Buster himself. The Mac and Henry Fugue Generator keyboard 118 promises to teach one to “play like Bach” in under five minutes and includes a compact disk and instruction booklet for the process.

Being a nefarious actor, with diabolical thoughts in mind, the shopper 120 also exclaims 125, “I'll just return it tomorrow . . . ” For this reason, the shopper price is no consideration for the shopper 120. Said differently, since the shopper 120 has no plans whatsoever to ultimately pay, he immediately eyes the Buster and His Bluesmen officially branded keyboard 116 because he knows the wedding guests will be amazed at this magnificent piece of gear and will tip the shopper 120 even more money when they hear its gorgeous bluesy sounds. The shopper 120 is clearly a textbook example of a dishonest customer exploiting a generous return policy to return a used item for a refund or exchange. As noted above, this results in financial losses for the poor keyboard vendor operating the electronic shopping interactive computing environment 117.

Advantageously, the system 100 of FIG. 1 is going to thwart this unsavory practice. Embodiments of the disclosure understand that the shopper 120 is well versed in contributing to the significant issue of fraudulent transactions in the e-commerce space, particularly focusing on fraudulent returns. Fraudsters such as the shopper 120 often exploit return policies by purchasing legitimate items and then returning fake or used items. Traditional methods to combat this, such as customer identity verification, restocking fees, and limiting return windows, are not entirely effective and can be costly to implement. Moreover, the fraudster knows he can attempt end runs around prior art practices by simply frequently resetting the computer, uninstalling and reinstalling applications, and changing SIM cards. These actions make tracking and preventing fraudulent activities difficult for merchants.

Advantageously, the system 100 of FIG. 1 involves tracking these suspicious behaviors by comparing this particular purchase by the shopper 120 to those he's made in the past. To wit, in one or more embodiments step 102 of FIG. 1 involves calculating the average price of products ordered by the shopper 120 in the past to determine averages both overall in the electronic shopping interactive computing environment 117 and per category, with the category of this illustrative example being musical keyboards. The electronic shopping interactive computing environment 117 employs various techniques to identify the shopper 120 and record their purchases. These techniques include using login information, device identifiers, phone numbers, email addresses, delivery addresses, and Internet Protocol (IP) addresses. By leveraging these identifiers, the system ensures accurate tracking of the shopper's purchase history.

The system calculates the average price of products ordered by the shopper 120 by aggregating the purchase prices of all items bought by the shopper 120. This aggregation includes both overall purchases and purchases within specific categories, such as musical keyboards. The average price overall and per category is then stored in a purchase log 112 on a per customer basis. This purchase log 112 serves as a comprehensive record of the shopper's buying behavior, enabling the system to identify patterns and anomalies in future transactions.

By maintaining detailed records in the purchase log 112, the electronic shopping interactive computing environment 117 can effectively monitor and analyze the shopper's purchasing behavior. This analysis helps in detecting potentially fraudulent activities by comparing the price of new orders with the historical average prices. The system can flag transactions where the price significantly deviates from the shopper's average purchase price, thereby enabling preventive measures to be taken to mitigate return fraud.

In one or more embodiments, step 103 of FIG. 1 involves calculating the average price of products returned by the shopper 120 in the past to determine averages both overall in the electronic shopping interactive computing environment 117 and per category. The electronic shopping interactive computing environment 117 employs various techniques to identify the shopper 120 and record their returns. These techniques include using login information, device identifiers, phone numbers, email addresses, delivery addresses, and Internet Protocol (IP) addresses. By leveraging these identifiers, the system ensures accurate tracking of the shopper's return history.

The system calculates the average price of products returned by the shopper 120 by aggregating the return prices of all items returned by the shopper 120. This aggregation includes both overall returns and returns within specific categories. The average price overall and per category is then stored in a return log 113 on a per customer basis. This return log 113 serves as a comprehensive record of the shopper's return behavior, enabling the system to identify patterns and anomalies in future transactions.

By maintaining detailed records in the return log 113, the electronic shopping interactive computing environment 117 can effectively monitor and analyze the shopper's return behavior. This analysis helps in detecting potentially fraudulent activities by comparing the price of new orders with the historical average return prices. The system can flag transactions where the price closely matches the shopper's average return price, thereby enabling preventive measures to be taken to mitigate return fraud.

In one or more embodiments, step 104 of FIG. 1 involves calculating the average price of products ordered by all customers in the past to determine averages both overall in the electronic shopping interactive computing environment 117 and per category. The electronic shopping interactive computing environment 117 employs various techniques to achieve this calculation. Initially, the system aggregates the purchase prices of all items bought by customers. This aggregation includes both overall purchases and purchases within specific categories, such as electronics, clothing, or home goods. The system then calculates the average price for each category by dividing the total purchase price by the number of items purchased within that category.

To ensure accuracy, the electronic shopping interactive computing environment 117 utilizes data from multiple sources, including transaction records, customer profiles, and product databases. The system identifies each transaction by using identifiers such as order numbers, customer identifiers, and product SKUs. By leveraging these identifiers, the system can accurately track and categorize each purchase. The calculated average prices, both overall and per category, are then stored in a category log 114 on a per customer basis. This category log 114 serves as a comprehensive record of purchasing behavior, enabling the system to identify patterns and anomalies in future transactions.

Additionally, the electronic shopping interactive computing environment 117 may employ data cleaning techniques to remove outliers and ensure the reliability of the average price calculations. Outliers, such as unusually high or low prices, can skew the average and may not accurately represent typical purchasing behavior. By filtering out these anomalies, the system can provide a more accurate reflection of average prices. The category log 114, therefore, contains refined data that can be used for various analytical purposes, including fraud detection, personalized recommendations, and inventory management.

In one or more embodiments, decision 105 compares, in response to user input from the shopper 120 initiating a shopping cart interaction event 123 in the electronic shopping interactive computing environment 117 operating on one or more processors of the electronic device 119, the shopping cart interaction event 123 to at least one previous user interaction event associated with the shopper in the electronic shopping interactive computing environment 117. In one or more embodiments, this can comprise a comparison to data stored in the purchase log 112, the return log 113, and/or the category log 114. In one or more embodiments, the comparison involves analyzing metrics such as the price of the item selected during the shopping cart interaction event 123 and comparing the price to historical data of the shopper's past purchases and returns. The system calculates the average price of products previously ordered and returned by the shopper, both overall and per category, and uses these averages as benchmarks for the comparison.

Where a metric associated with the at least one previous user interaction event deviates from a corresponding metric associated with the shopping cart interaction event, the system flags the transaction for further review. This deviation may indicate potential fraudulent behavior, such as purchasing an item significantly more expensive than the shopper's usual purchases or closely matching the price of items frequently returned by the shopper. Upon detecting such a deviation, the system moves to decision 108 to determine whether the product being selected by the shopping cart interaction event 123 has a return policy. This step ensures that the system can apply appropriate preventive measures, such as converting the return option to an exchange-only policy or blocking the new order, thereby mitigating the risk of return fraud and protecting the retailer's financial stability.

In one or more embodiments, the metric comprises a price of an item that is subject of the shopping cart interaction event 123 and the corresponding metric comprises an average price of items purchased by previous shopping cart interaction events made by the shopper 120 in the electronic shopping interactive computing environment, which is stored in the purchase log 112. Illustrating by example, if the shopper's average purchase price in the electronic shopping interactive computing environment 117 is under $100, and the shopper 120 is now trying to buy the fancy Buster and his Bluesmen keyboard for $2000, decision 105 may move to decision 108, rather than taking no action at step 107.

This can be done on a per category or overall basis. Said differently, in other embodiments, the metric comprises a price of an item that is subject of the shopping cart interaction event 123 and the corresponding metric comprises an average price of a category of items corresponding to the item and purchased by previous shopping cart interaction events made by the shopper 120 in the electronic shopping interactive computing environment 117. Using this metric, if the shopper's average musical instrument purchase price were under $1000, e.g., if he had purchased the Mac and Henry Fugue Generator for $800 in the past, decision 105 may move to decision 108, rather than taking no action at step 107, and so forth.

In the illustrative embodiment of FIG. 1, decision 105 determines the metric associated with the at least one at least one previous user interaction event deviates from the corresponding metric associated with the shopping cart interaction event 123 when the price of the selected keyboard is greater than N times the average price of the past purchases made by the shopper 120 stored in the purchase log 112. In one or more embodiments, N is a number greater than or equal to two. Illustrating by example, if N is three, and if the shopper's average purchase price in the electronic shopping interactive computing environment 117 is $300, the shopper's attempt to buy the fancy Buster and his Bluesmen keyboard for $2000 would exceed three times $300, or $900, and thus decision 105 may move to decision 108, rather than taking no action at step 107.

In one or more embodiments, decision 106 compares, in response to user input from the shopper 120 initiating a shopping cart interaction event 123 in the electronic shopping interactive computing environment 117 operating on one or more processors of the electronic device 119, the shopping cart interaction event 123 to at least one previous user interaction event associated with the shopper in the electronic shopping interactive computing environment 117. At decision 106, the comparison involves analyzing metrics such as the price of the item selected during the shopping cart interaction event 123 and comparing the price to historical data of the shopper's past returns. The system calculates the average price of products previously returned by the shopper, both overall and per category, and uses these averages as benchmarks for the comparison.

Where a metric associated with the at least one previous user interaction event deviates from a corresponding metric associated with the shopping cart interaction event, the system flags the transaction for further review. This deviation may indicate potential fraudulent behavior, such as purchasing an item significantly more expensive than the shopper's usual returns or closely matching the price of items frequently returned by the shopper. Upon detecting such a deviation, the system moves to decision 108 to determine whether the product being selected by the shopping cart interaction event 123 has a return policy. This step ensures that the system can apply appropriate preventive measures, such as converting the return option to an exchange-only policy or blocking the new order, thereby mitigating the risk of return fraud and protecting the retailer's financial stability.

In one or more embodiments, the metric comprises a price of an item that is subject of the shopping cart interaction event 123 and the corresponding metric comprises an average price of items returned by previous shopping cart interaction events made by the shopper 120 in the electronic shopping interactive computing environment, which is stored in the return log 113. Illustrating by example, if the shopper's average price of returned items in the electronic shopping interactive computing environment 117 is under $100, and the shopper 120 is now trying to buy the fancy Buster and his Bluesmen keyboard for $2000, which could lead to a return request for $2000, decision 105 may move to decision 108, rather than taking no action at step 107.

This can be done on a per category or overall basis. Said differently, in other embodiments, the metric comprises a price of an item that is subject of the shopping cart interaction event 123 and the corresponding metric comprises an average price of a category of items corresponding to the item and returned from previous shopping cart interaction events made by the shopper 120 in the electronic shopping interactive computing environment 117. Using this metric, if the shopper 120 returns musical instruments having an average musical instrument purchase price under $1000, e.g., if he had returned the Mac and Henry Fugue Generator for $800 in the past, decision 105 may move to decision 108, rather than taking no action at step 107, and so forth.

In the illustrative embodiment of FIG. 1, decision 105 determines the metric associated with the at least one at least one previous user interaction event deviates from the corresponding metric associated with the shopping cart interaction event 123 when the price of the selected keyboard is greater than N times the average price of the past returns made by the shopper 120 stored in the return log 113. In one or more embodiments, N is a number greater than or equal to two. Illustrating by example, if N is three, and if the shopper's return purchase price in the electronic shopping interactive computing environment 117 is $300, the shopper's attempt to buy the fancy Buster and his Bluesmen keyboard for $2000 would exceed three times $300, or $900, and thus decision 105 may move to decision 108, rather than taking no action at step 107.

It should be noted too that while comparisons can be made to the shopper's past transactions, embodiments of the disclosure contemplate that the shopper 120 may be new to the electronic shopping interactive computing environment 117, i.e., without any or any extensive history stored in the purchase log 112 or the return log 113. Accordingly, in such instances the metric can comprise a price of an item that is subject of the shopping cart interaction event 123 and the corresponding metric can comprise an average price of a category of items corresponding to the item that are available in the electronic shopping interactive computing environment 117.

This can be done on a per category or overall basis. Said differently, in other embodiments the metric comprises a price of an item that is subject of the shopping cart interaction event 123 and the corresponding metric comprises a scaled average price of a category of items corresponding to the item that are available in the electronic shopping interactive computing environment 117. Other metrics will be obvious to those of ordinary skill in the art having the benefit of this disclosure.

Decision 108 determines whether the product associated with the shopping cart interaction event 123 has a return policy associated therewith by analyzing the product's metadata within the electronic shopping interactive computing environment. The system retrieves the return policy information from the product database, which includes details such as return eligibility, return window, and any specific conditions or restrictions applicable to the product. This decision 108 ensures that the system accurately identifies whether the product can be returned under the current return policy before proceeding with any preventive measures.

This determination is necessary because affirmative decisions from either decision 105 or decision 106, where a metric associated with at least one previous user interaction event deviates from a corresponding metric associated with the shopping cart interaction event, result in step 109 presenting a prompt on a user interface of the electronic device. This prompt indicates that any additional shopping cart interaction events will be unavailable for product return user interaction events in the electronic shopping interactive computing environment. By confirming the presence of a return policy, decision 108 ensures that the system only applies preventive measures to products that are eligible for returns, thereby maintaining the integrity and fairness of the return process for both the retailer and the customer.

In one or more embodiments, when decision 105 or decision 106 determines a metric associated with the at least one previous user interaction event deviates from a corresponding metric associated with the shopping cart interaction event 123, step 109 comprises presenting, by the one or more processors, a prompt on a user interface of the electronic device 119 indicating that any additional shopping cart interaction events will be unavailable for product return user interaction events in the electronic shopping interactive computing environment 117. This prompt serves to inform the user that due to the detected anomaly in their purchasing behavior, the system has restricted the ability to return the item in question. The prompt provides immediate feedback to the user, thereby enhancing transparency and user awareness regarding the restrictions being applied.

In one or more embodiments, the prompt is presented only when the electronic shopping interactive computing environment 117 has a predefined return policy for an item that is subject of the shopping cart interaction event 123. This ensures that the system applies the preventive measure of restricting return options only to items that are eligible for returns under the current return policy. By confirming the presence of a return policy, the system maintains the integrity and fairness of the return process for both the retailer and the customer. This approach helps in mitigating the risk of return fraud while ensuring that legitimate transactions are not unduly affected.

When the prompt is presented, return mitigation measures may be applied as well. Advantageously, these measures may include blocking the user from making new orders, alerting the user that no return facility is available for new orders, or blocking the device from accessing the online shopping application altogether. This proactive approach aims to mitigate the risk of fraudulent returns, thereby protecting retailers from financial losses and maintaining the integrity of the e-commerce platform.

In one or more embodiments, when the metric associated with the at least one previous user interaction event deviates from a corresponding metric associated with the shopping cart interaction event 123, as determined by decision 105 and 106, the measure ensuring any additional shopping cart interaction events will be unavailable for product return user interaction events in the electronic shopping interactive computing environment 117 comprises precluding all user interaction events from occurring in the electronic shopping interactive computing environment 117 at step 109. In one or more embodiments, when the metric associated with the at least one previous user interaction event deviates from a corresponding metric associated with the shopping cart interaction event 123, as determined by decision 105 and 106, the measure ensuring any additional shopping cart interaction events will be unavailable for product return user interaction events in the electronic shopping interactive computing environment 117 comprises precluding a shopping cart interaction event from occurring in the electronic shopping interactive computing environment 117 at step 109. Effectively, this blocks the shopper's ability to place orders.

In one or more embodiments, when the metric associated with the at least one previous user interaction event deviates from a corresponding metric associated with the shopping cart interaction event 123, as determined by decision 105 and 106, the measure ensuring any additional shopping cart interaction events will be unavailable for product return user interaction events in the electronic shopping interactive computing environment 117 comprises presenting a prompt on a user interface of the electronic device indicating that any shopping cart interaction events will be unavailable for product return user interaction events in the electronic shopping interactive computing environment 117 at step 109. While this may allow the shopper 120 to buy that fancy Buster and His Bluesmen officially branded keyboard 116, he will not be able to return it at a later date due to his nefarious intentions. Thus, in one or more embodiments step 109 precludes any product return user interaction events corresponding to shopping cart interaction events occurring after presentation of the prompt.

After the prompt is presented at step 109, the system queries the shopper 120 at decision 110 to determine whether the shopper 120 wishes to proceed with the order despite the restrictions on return options. The prompt informs the shopper 120 that the order will not be eligible for returns due to detected anomalies in purchasing behavior. This prompt serves to provide transparency and immediate feedback to the shopper 120 regarding the consequences of their purchasing actions.

If the shopper 120 chooses to proceed with the order, step 111 allows the order to proceed. The system processes the order as usual, but with the return option converted to an exchange-only policy or completely blocked. This ensures that the shopper 120 is aware of and consents to the restrictions before finalizing the purchase, thereby reducing the likelihood of fraudulent returns.

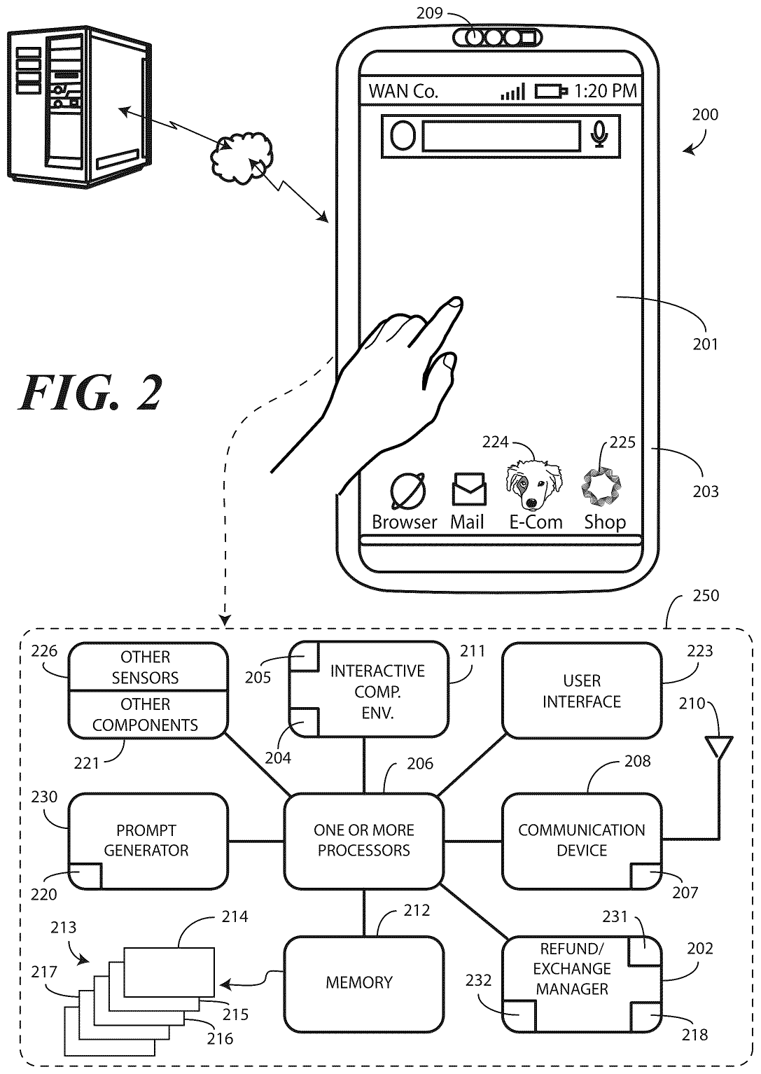

If the shopper 120 decides not to proceed with the order, step 107 takes no further action. The system cancels the order process, and the shopper 120 can continue browsing or shopping without any additional restrictions. This approach provides a balanced solution, allowing legitimate shoppers to make informed decisions while deterring potentially fraudulent activities Turning now to FIG. 2, illustrated therein is one explanatory electronic device 200 configured in accordance with one or more embodiments of the disclosure. The electronic device 200 of this illustrative embodiment includes a user interface 223. In one or more embodiments, the user interface 223 comprises a display 201, which may optionally be touch-sensitive. The display 201 can serve as a primary user interface 223 of the electronic device 200.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 250 of the electronic device 200 is also shown in FIG. 2. In one embodiment, the electronic device 200 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 200. Each of the application processor and the auxiliary processor(s) can be configured to process and execute executable software code to perform the various functions of the electronic device 200. A storage device, such as memory 212, can optionally store the executable software code used by the one or more processors 206 during operation.

In this illustrative embodiment, the electronic device 200 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 200 can optionally include a near field communication circuit 207 used to exchange data, power, and electrical signals between the electronic device 200 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include-as an antenna-a communication coil that is configured for near-field communication at a particular communication frequency.

The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 200. For example, in one embodiment the one or more processors 206 comprise one or more circuits operable to present presentation information, such as images, text, and video, on the display 201. When an electronic shopping application 225 is actuated, the one or more processors 206 can present an electronic shopping interactive computing environment 211 to a user on the display 201, within which the user can enter an interactive session 204 and make user interaction events. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 200.

The application service layer 215 can be responsible for executing application service modules. The application service modules may support one or more applications 217 or “apps. ” Examples of such applications include a cellular telephone application for making voice telephone calls, a web browsing application configured to allow the user to view webpages on the display 201 of the electronic device 200, an electronic mail application configured to send and receive electronic mail, a photo application configured to organize, manage, and present photographs on the display 201 of the electronic device 200, and a camera application for capturing images with the imager 209.

Collectively, these applications constitute an “application suite.” In one or more embodiments, these applications comprise one or more e-commerce applications 224 and/or electronic shopping applications 225 that allow electronic commerce orders to be placed and financial transactions to be made using the electronic device 200.

Illustrating by example, in one or more embodiments a user can deliver user input to an e-commerce application 224 to launch an interactive session 204 of an electronic shopping interactive computing environment 211 that operates on the one or more processors 206. They can then deliver user input to the user interface 223 to define one or more search strings corresponding to one or more categories within the electronic shopping interactive computing environment 211.

The one or more processors 206 can then monitor user interaction events in the electronic shopping interactive computing environment 211 to compare a price 205 of the item with at least a first metric 218 associated with past purchases made by the user in the electronic shopping application 225 and at least a second metric 231 associated with past returns made by the user in the electronic shopping application 225 as previously described.

In one or more embodiments, in response to the one or more processors 206 detecting commencement of an interactive session 204 of an electronic shopping application 225 operating on the one or more processors 206 and an item selection by a shopping cart interaction event 232 made by a user in an interactive shopping session 204 in an electronic shopping application 225 operating on the one or more processors 206, the one or more processors 206, using a refund/exchange manager 202 can compare a price 205 of the item with at least a first metric 218 associated with past purchases made by the user in the electronic shopping application 225 and at least a second metric 231 associated with past returns made by the user in the electronic shopping application 225.

In one or more embodiments, when either the price 205 exceeds the first metric 218 by a predefined threshold or the price 205 exceeds the second metric 231 by a predefined threshold, the one or more processors 206 preclude product return user interaction events from occurring in the electronic shopping application 225. This means returns will not be permitted.

In one or more embodiments, when either the price 205 exceeds the first metric 218 by the predefined threshold or the price exceeds the second metric 231 by the predefined threshold, the one or more processors 206 preclude shopping cart completion user interaction events for the item, which means that the shopper will be unable to purchase the item. In one or more embodiments, the one or more processors 206 even terminate the interactive shopping session 204.

In one or more embodiments, the first metric 218 comprises an average price of a category of items corresponding to the item and purchased by previous shopping cart interaction events made by the user in the electronic shopping interactive computing environment 211. In one or more embodiments, the second metric 231 comprises another average price of the category of items corresponding to the item and returned by previous user interaction events made by the user in the electronic shopping interactive computing environment 211.

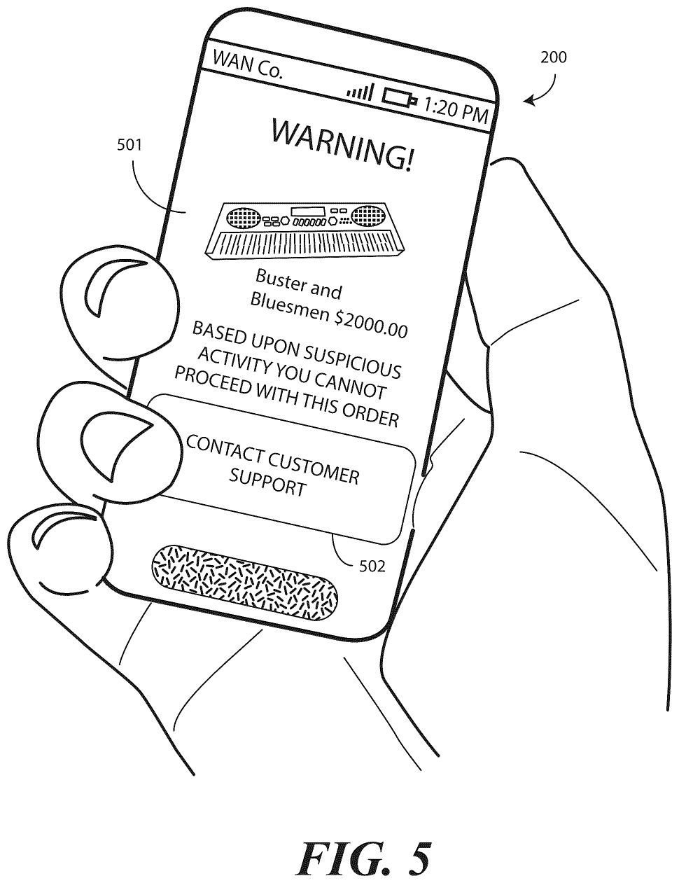

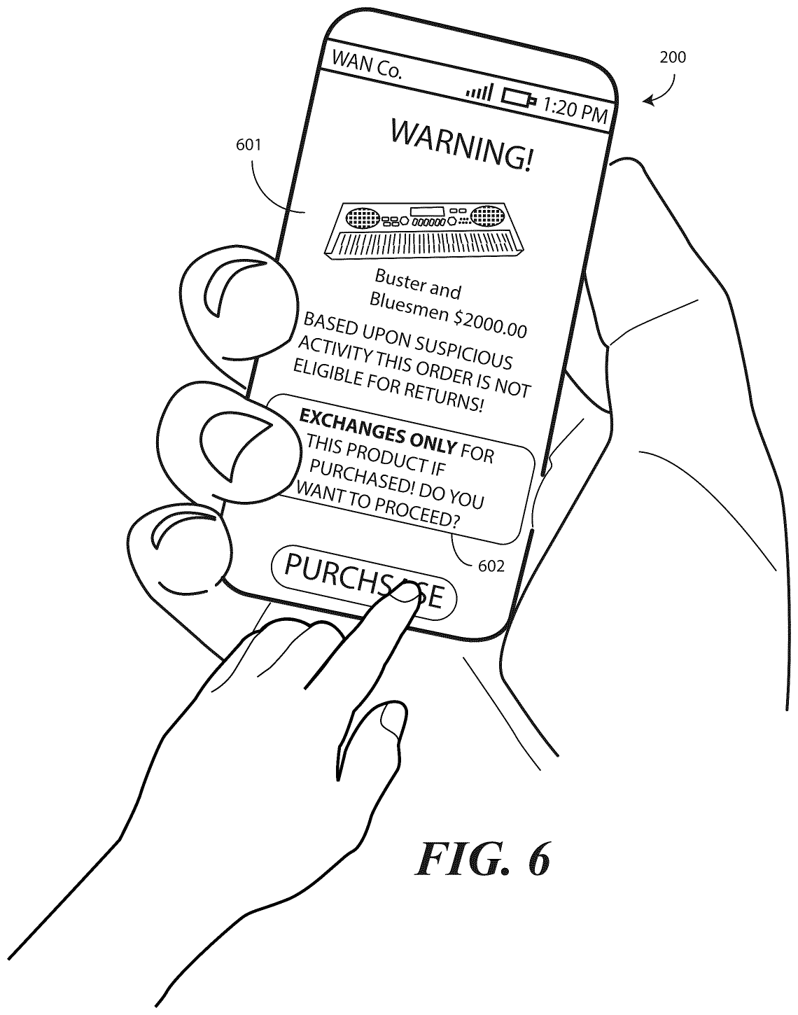

In one or more embodiments, the one or more processors 206 further cause the user interface 223 to present a prompt 220 identifying which of the one or both of the shopping cart user interaction events and/or the product return user interaction events is precluded from occurring in the electronic shopping application 225. In one or more embodiments, a prompt generator 230 generates this prompt. Turning briefly to FIGS. 5-6, illustrated therein are examples of such a prompt.

Beginning with FIG. 5, illustrated therein is the electronic device 200 displaying a first prompt 501. In one or more embodiments, this prompt 501 appears when either the price exceeds the first metric by a predefined threshold, or the price exceeds the second metric by a predefined threshold. Presentation of the prompt 501 can accompany the one or more processors of the electronic device precluding product return user interaction events from occurring in the electronic shopping application.

In this illustrative embodiment, the prompt 501 informs the user that, based on suspicious activity detected on the device, the user cannot proceed with the order. The message displayed on the electronic device 200 reads: “BASED UPON SUSPICIOUS ACTIVITY YOU CANNOT PROCEED WITH THIS ORDER.” This notification indicates that the system has detected behavior indicative of potential fraud and has taken preventive measures to restrict the user's ability to place orders. A sub-prompt 502 allows the user to contact customer support in the event they believe this prompt 501 to be erroneously presented.

In one or more embodiments, the electronic device 200 still allows interaction with the electronic shopping application. Thus, the user could still purchase less expensive products including the “Hard Rockin'/Honky Tonkin'” keyboard or the “Mac and Henry Fugue Generator” keyboard. However, the shopper is precluded from ordering the “Buster and his Bluesmen” keyboard due to its price deviating significantly from one or more of past purchases by the user, past purchases in the same category by the user, past returns by the user, past returns in the same category by the user, past purchases made by all users of the electronic shopping interactive computing environment, and/or past purchases in the same category made by all users of the electronic shopping interactive computing environment.

A “CONTACT CUSTOMER SUPPORT” user actuation target is also displayed in the sub-prompt 502 on the electronic device 200. This target allows the user to contact customer support if the user believes the prompt 501 is shown in error. This feature ensures that legitimate users who may have been incorrectly flagged can resolve the issue and regain access to the shopping application. FIG. 5 also shows the purchase user actuation target having been greyed out so that it becomes inactive and includes the greying as a visual indicator of its inactive status.

Turning now to FIG. 6, illustrated therein is the electronic device 200 presenting still another prompt 601 because either the price exceeds the first metric by a predefined threshold, or the price exceeds the second metric by a predefined threshold. The prompt 601 prominently displays the product information for the Buster and His Bluesmen keyboard, including the price of $2000.00. The warning message reads: “BASED UPON SUSPICIOUS ACTIVITY THIS ORDER IS NOT ELIGIBLE FOR RETURNS!” This notification informs the user that, due to the price deviating significantly from one or more of past purchases by the user, past purchases in the same category by the user, past returns by the user, past returns in the same category by the user, past purchases made by all users of the electronic shopping interactive computing environment, and/or past purchases in the same category made by all users of the electronic shopping interactive computing environment, they will not be able to return the keyboard if they decide to purchase the keyboard.

A sub-prompt 602 is also displayed, indicating “NO RETURNS ALLOWED!” This sub-prompt 602 reinforces the restriction on returns for the specified product. Despite the restriction, the user can still proceed with the purchase by selecting the “PURCHASE” button displayed on the screen.

The electronic device 200 ensures that users identified as high-risk for fraudulent returns are restricted from performing return actions, thereby protecting retailers from potential financial losses. The system leverages device-level data to calculate the fraudulent return propensity score, enhancing the accuracy of fraud detection and maintaining the integrity of the e-commerce platform.

It should be noted that the prompts 501,601 of FIGS. 5-6 are illustrative only. Others suitable for presentation when the price deviates significantly from one or more of past purchases by the user, past purchases in the same category by the user, past returns by the user, past returns in the same category by the user, past purchases made by all users of the electronic shopping interactive computing environment, and/or past purchases in the same category made by all users of the electronic shopping interactive computing environment.

Turning now back to FIG. 2, in one or more embodiments the one or more processors 206 are responsible for managing the applications and all personal information received from the user interface 223 that is to be used by the e-commerce application 224 and/or electronic shopping application 225 after the electronic device 200 is authenticated as a secure electronic device and the user identification credentials have triggered an electronic payment transaction request to complete an electronic shopping cart interaction event. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 200 is reported stolen or when the e-commerce application 224 and/or electronic shopping application 225 are used with fraudulent activity to wipe the memory 212 clean of any personal data, preferences, or settings of the person previously using the electronic device 200.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 200 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 200.

In one or more embodiments, the electronic device 200 comprises a prompt generator 230 as well. In one or more embodiments, the prompt generator generates a prompt 220 identifying whether the one or both of shopping cart user interaction events and/or product return user interaction events will be precluded from occurring in the electronic shopping interactive computing environment 211. In one or more embodiments, the prompt 220 is presented by the one or more processors 206 on the user interface 223 in response to the price deviating significantly from one or more of past purchases by the user, past purchases in the same category by the user, past returns by the user, past returns in the same category by the user, past purchases made by all users of the electronic shopping interactive computing environment, and/or past purchases in the same category made by all users of the electronic shopping interactive computing environment.

In one or more embodiments, the refund/exchange manager 202 and the prompt generator 230 can be operable with one or more processors 206, configured as a component of the one or more processors 206, or configured as one or more executable code modules operating on the one or more processors 206. In other embodiments, the refund/exchange manager 202 and the prompt generator 230 can be standalone hardware components operating executable code or firmware to perform their functions. Other configurations for the refund/exchange manager 202 and the prompt generator 230 will be obvious to those of ordinary skill in the art having the benefit of this disclosure.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

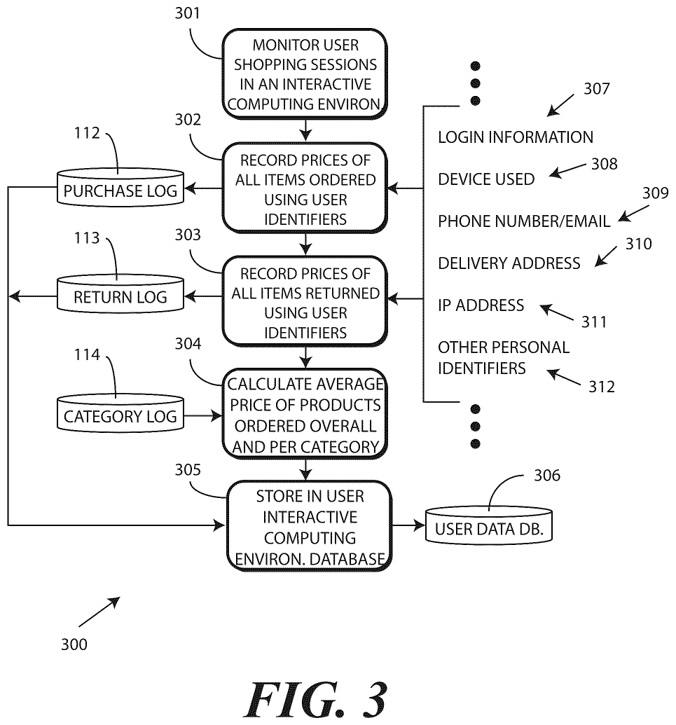

Turning now to FIG. 3, illustrated therein is one explanatory method 300 in accordance with one or more embodiments of the disclosure. The method 300 of FIG. 3 tracks data in an electronic shopping interactive computing environment to log one or more of past purchases by the user, past purchases in the same category by the user, past returns by the user, past returns in the same category by the user, past purchases made by all users of the electronic shopping interactive computing environment, and/or past purchases in the same category made by all users of the electronic shopping interactive computing environment so that subsequent shopping cart interaction events can be compared to this historic data.

In one or more embodiments, step 301 of the method 300 involves monitoring user interaction events within an electronic shopping interactive computing environment. The system records data related to past purchases by the user into a purchase log 112 at step 302, past purchases in the same category by the user into the purchase log 112 at step 302, past returns by the user into the return log 113 at step 303, past returns in the same category by the user into the return log 113 at step 303, past purchases made by all users of the electronic shopping interactive computing environment into the category log 114 at step 304, and past purchases in the same category made by all users of the electronic shopping interactive computing environment into the category log 114 at step 304. In one or more embodiments, the system employs various techniques to identify the user and accurately log their transactions. These techniques include using login information 307, device identifiers 308, phone numbers and email addresses 309, delivery addresses 310, Internet Protocol (IP) addresses 311, and other personal identifiers 312.

In one or more embodiments, the system aggregates the purchase prices of all items bought by the user at step 302, both overall and within specific categories, to calculate average prices that are stored in a the purchase log 112 at step 302. This aggregation includes both overall purchases and purchases within specific categories, such as electronics, clothing, or home goods. The calculated average prices are then stored in a purchase log 112 on a per-customer basis at step 302. Similarly, the system aggregates the return prices of all items returned by the user at step 303, both overall and within specific categories, to calculate average return prices. These averages are stored in a return log 113 on a per-customer basis.

Additionally, the system calculates the average price of products ordered by all users in the past at step 304, both overall and per category. This involves aggregating the purchase prices of all items bought by all users and calculating the average price for each category. The calculated average prices are stored in a category log 114. The system may employ data cleaning techniques to remove outliers and ensure the reliability of the average price calculations. By maintaining detailed records in the purchase log, return log, and category log, the system can effectively monitor and analyze purchasing and returning behavior, which is stored in a user data database 306 at step 305, thereby enabling the detection of potentially fraudulent activities by comparing the price of new orders with historical average prices.

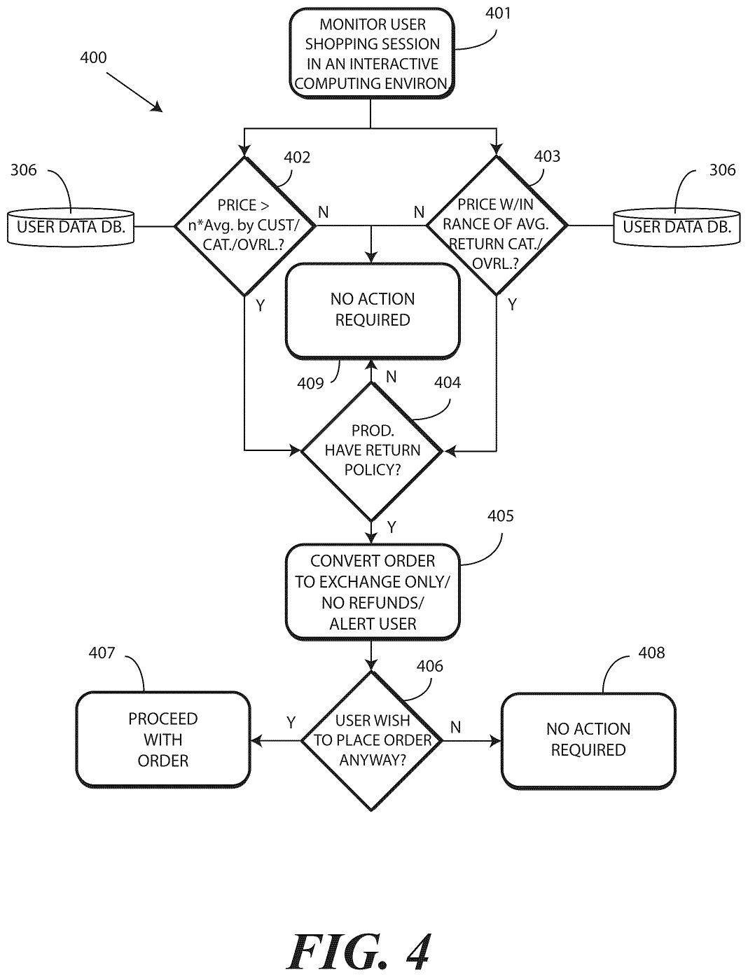

Turning now to FIG. 4, illustrated therein is one explanatory method 400 in accordance with one or more embodiments of the disclosure. In one or more embodiments, step 401 of FIG. 4 monitors user shopping sessions in an electronic shopping interactive computing environment by employing various techniques to track and analyze user interactions. One method involves using session cookies to maintain a record of user activities within a single browsing session.

Session cookies store temporary data that can track items viewed, added to the cart, and other interactions, allowing the system to analyze user behavior in real-time. This step 401 provides immediate insights into user preferences and potentially fraudulent activities, enabling prompt preventive measures.

Another approach that can be used at step 401 involves utilizing server-side logging to capture detailed records of user interactions. Server-side logging records every action taken by the user, such as page visits, clicks, and form submissions, and stores this data on the server. This method offers a comprehensive view of user behavior over time, facilitating the identification of patterns and anomalies that may indicate fraudulent activities. By analyzing server logs, the system can detect unusual purchasing behaviors and flag them for further review.

Additionally, step 401 can employ client-side monitoring techniques, such as JavaScript event listeners, to capture user interactions directly within the browser. JavaScript event listeners can track specific actions, such as mouse movements, clicks, and keystrokes, providing granular data on user behavior. This method allows for real-time monitoring and immediate response to suspicious activities, enhancing the system's ability to prevent fraudulent transactions.

Each of these methods offers distinct advantages. Session cookies provide real-time tracking and immediate insights, server-side logging offers a comprehensive historical view of user behavior, and client-side monitoring delivers granular data for detailed analysis. By combining these techniques, the system can effectively monitor user shopping sessions, identify potential fraud, and implement preventive measures to safeguard the integrity of the electronic shopping interactive computing environment.

In one or more embodiments, in response to user input from a user initiating a shopping cart interaction event in an electronic shopping interactive computing environment operating on one or more processors of the electronic device, decision 402 and decision 403 compare, by the one or more processors a price of an item that is subject of the shopping cart interaction event to one or more metrics. Illustrating by example, in one or more embodiments decision 402 compares the price of the item that is subject of the shopping cart interaction event to both a first summary price of products ordered by the user, both overall and per a category associated with the item, and a third summary price of products available in the electronic shopping interactive computing environment, both overall and per the category.

Decision 403 then compares the price of the item that is subject to the shopping cart interaction event to a second summary price of products returned by the user, both overall and per the category. These metrics are stored in the user data database in accordance with the method (300) described in FIG. 3 above. In one or more embodiments, the first summary price, the second summary price, and the third summary price comprise median prices.

In one or more embodiments, where the price exceeds any of the first summary price, the second summary price, or the third summary price, as determined by either decision 402 or decision 403, the method 400 moves to decision 404 where it is determined whether the item that is subject of the shopping cart interaction event has a return policy. This occurs because, in one or more embodiments, where the price exceeds any of the first summary price, the second summary price, or the third summary price the method 400 precludes product return user interaction events for the item from occurring in the electronic shopping interactive computing environment at step 405. Otherwise, no action is taken at step 409.

Step 405 can further comprise presenting a prompt on a user interface of the electronic device indicating that any additional shopping cart interaction events will be unavailable for product return user interaction events in the electronic shopping interactive computing environment. One such prompt (601) was described with reference to FIG. 6 above. Others will be obvious to those of ordinary skill in the art having the benefit of this disclosure.

Decision 406 determines whether the shopper wishes to proceed with the purchase after the presentation of the prompt at step 405 by querying the shopper through the user interface of the electronic device. The prompt presented at step 405 informs the shopper that the order will not be eligible for returns due to detected anomalies in purchasing behavior. This prompt serves to provide transparency and immediate feedback to the shopper regarding the consequences of their purchasing actions. The system waits for the shopper's response to this prompt to decide the next course of action.

If the shopper chooses to proceed with the purchase despite the restrictions on return options, step 407 allows the order to be placed. The system processes the order as usual, but with the return option converted to an exchange-only policy or completely blocked. This ensures that the shopper is aware of and consents to the restrictions before finalizing the purchase, thereby reducing the likelihood of fraudulent returns. The system records the transaction details and updates the shopper's purchase history accordingly.

If the shopper decides not to proceed with the purchase, step 408 takes no further action. The system cancels the order process, and the shopper can continue browsing or shopping without any additional restrictions. This approach provides a balanced solution, allowing legitimate shoppers to make informed decisions while deterring potentially fraudulent activities. The system logs the shopper's decision and maintains a record of the interaction for future reference.

In the context of FIG. 4, the shopper (120) described above in FIG. 1 as looking for a fancy keyboard for a gig, would be precluded from returning the Buster and His Bluesmen keyboard (116) using the method 400. The process begins with step 401, where the system monitors the user shopping session in the electronic shopping interactive computing environment (117). As the shopper (120) selects the Buster and His Bluesmen keyboard (116), the system proceeds to decision 402 to compare the price of the keyboard with the shopper's average purchase price, both overall and per category. Given that the Buster and His Bluesmen keyboard (116) is significantly more expensive than the shopper's usual purchases, the price likely exceeds the predefined threshold, triggering a move to step 405 since this fancy keyboard has a return policy, as determined by decision 404.

Since the keyboard has a return policy, step 405 converts the order to an exchange-only policy, alerting the shopper (120) that no refunds will be available. This step prevents potential return fraud, as it ensures that high-value items, which deviate significantly from the shopper's average purchase behavior, are not easily returned for a refund. The system then presents a prompt to the shopper (120), asking if they wish to proceed with the order despite the return restrictions.

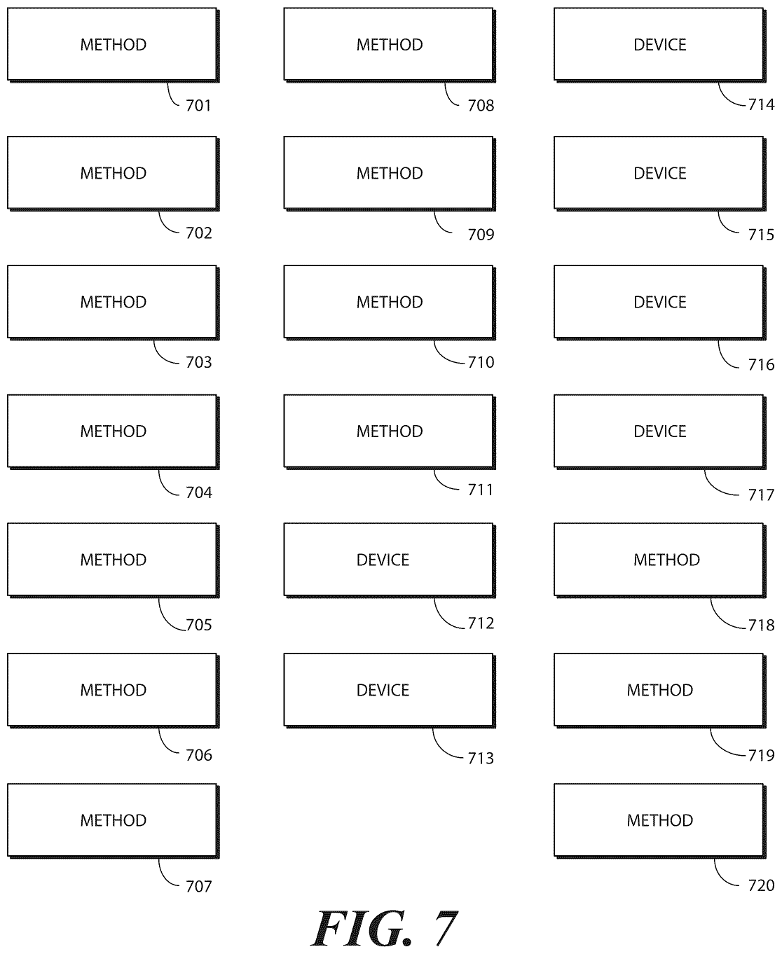

If the shopper (120) decides to proceed with the purchase, as determined at decision 406, the system allows the order to be placed at step 407. However, if the shopper (120) chooses not to proceed, the system takes no further action at step 408, effectively canceling the order. This method 400 ensures that the shopper (120) cannot exploit the return policy for high-value items like the Buster and His Bluesmen keyboard (116), thereby protecting the retailer from potential financial losses and maintaining the integrity of the return system Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises, in response to user input from a user initiating a shopping cart interaction event in an electronic shopping interactive computing environment operating on one or more processors of the electronic device, comparing, by the one or more processors, the shopping cart interaction event to at least one previous user interaction event associated with the user in the electronic shopping interactive computing environment. At 701, the method comprises, where a metric associated with the at least one previous user interaction event deviates from a corresponding metric associated with the shopping cart interaction event, presenting, by the one or more processors, a prompt on a user interface of the electronic device indicating that any additional shopping cart interaction events will be unavailable for product return user interaction events in the electronic shopping interactive computing environment.

At 702, the metric of 701 comprises a price of an item that is subject of the shopping cart interaction event and the corresponding metric comprises an average price of items purchased by previous shopping cart interaction events made by the user in the electronic shopping interactive computing environment. At 703, the metric of 702 associated with the at least one previous user interaction event deviates from the corresponding metric associated with the shopping cart interaction events when the price is greater than N times the average price. At 704, the N value from 703 is greater than or equal to two.

At 705, the metric of 701 comprises a price of an item that is subject of the shopping cart interaction event and the corresponding metric comprises an average price of a category of items corresponding to the item and purchased by previous shopping cart interaction events made by the user in the electronic shopping interactive computing environment. At 706, the metric of 701 comprises a price of an item that is subject of the shopping cart interaction event and the corresponding metric comprises an average price of items returned by previous user interaction events made by the user in the electronic shopping interactive computing environment. At 707, the metric of 706 associated with the at least one previous user interaction event deviates from the corresponding metric associated with the shopping cart interaction events when the price is greater than N times the average price of the items returned.

At 708, the metric of 701 comprises a price of an item that is subject of the shopping cart interaction event and the corresponding metric comprises an average price of a category of items corresponding to the item and returned by previous user interaction events made by the user in the electronic shopping interactive computing environment. At 709, the prompt of 701 is presented only when the electronic shopping interactive computing environment has a predefined return policy for an item that is subject of the shopping cart interaction event.

At 710, the metric of 701 comprises a price of an item that is subject of the shopping cart interaction event and the corresponding metric comprises an average price of a category of items corresponding to the item that are available in the electronic shopping interactive computing environment. At 711, the metric of 701 comprises a price of an item that is subject of the shopping cart interaction event and the corresponding metric comprises a scaled average price of a category of items corresponding to the item that are available in the electronic shopping interactive computing environment.

At 712, an electronic device comprises a user interface, a memory, and one or more processors operable with the user interface and the memory. At 712, in response to the one or more processors detecting an item selection by a shopping cart interaction event made by a user in an interactive shopping session in an electronic shopping application operating on the one or more processors, the one or more processors compare a price of the item with at least a first metric associated with past purchases made by the user in the electronic shopping application and at least a second metric associated with past returns made by the user in the electronic shopping application. At 712, when either the price exceeds the first metric by a predefined threshold or the price exceeds the second metric by a predefined threshold, the one or more processors preclude product return user interaction events from occurring in the electronic shopping application.

At 713, when either the price exceeds the first metric by the predefined threshold or the price exceeds the second metric by the predefined threshold, the one or more processors of 712 preclude shopping cart completion user interaction events for the item. At 714, the one or more processors of 713 further terminate the interactive shopping session.

At 715, the one or more processors of 712 further cause the user interface to present a prompt indicating that the product return user interaction events have been precluded from occurring in the electronic shopping application. At 716, the first metric of 715 comprises an average price of a category of items corresponding to the item and purchased by previous shopping cart interaction events made by the user in the electronic shopping interactive computing environment. At 717, the second metric of 715 comprises another average price of the category of items corresponding to the item and returned by previous user interaction events made by the user in the electronic shopping interactive computing environment.

At 718, a method in an electronic device comprises, in response to user input from a user initiating a shopping cart interaction event in an electronic shopping interactive computing environment operating on one or more processors of the electronic device, comparing, by the one or more processors a price of an item that is subject of the shopping cart interaction event to a first summary price of products ordered by the user, both overall and per a category associated with the item, a second summary price of products returned by the user, both overall and per the category, and a third summary price of products available in the electronic shopping interactive computing environment, both overall and per the category. At 718, where the price exceeds any of the first summary price, the second summary price, or the third summary price, the method comprises precluding product return user interaction events for the item from occurring in the electronic shopping interactive computing environment.

At 719, the method of 718 further comprises presenting, by the one or more processors, a prompt on a user interface of the electronic device indicating that any additional shopping cart interaction events will be unavailable for product return user interaction events in the electronic shopping interactive computing environment. At 720, the first summary price, the second summary price, and the third summary price of 718 comprise median prices.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
in response to user input from a user initiating a shopping cart interaction event in an electronic shopping interactive computing environment operating on one or more processors of the electronic device, comparing, by the one or more processors, the shopping cart interaction event to at least one previous user interaction event associated with the user in the electronic shopping interactive computing environment; and
where a metric associated with the at least one previous user interaction event deviates from a corresponding metric associated with the shopping cart interaction event, presenting, by the one or more processors, a prompt on a user interface of the electronic device indicating that any additional shopping cart interaction events will be unavailable for product return user interaction events in the electronic shopping interactive computing environment.

2. The method of claim 1, wherein the metric comprises a price of an item that is subject of the shopping cart interaction event and the corresponding metric comprises an average price of items purchased by previous shopping cart interaction events made by the user in the electronic shopping interactive computing environment.

3. The method of claim 2, wherein the metric associated with the at least one at least one previous user interaction event deviates from the corresponding metric associated with the shopping cart interaction events when the price is greater than N times the average price.

4. The method of claim 3, where N is greater than or equal to two.

5. The method of claim 1, wherein the metric comprises a price of an item that is subject of the shopping cart interaction event and the corresponding metric comprises an average price of a category of items corresponding to the item and purchased by previous shopping cart interaction events made by the user in the electronic shopping interactive computing environment.

6. The method of claim 1, wherein the metric comprises a price of an item that is subject of the shopping cart interaction event and the corresponding metric comprises an average price of items returned by previous user interaction events made by the user in the electronic shopping interactive computing environment.

7. The method of claim 6, wherein the metric associated with the at least one at least one previous user interaction event deviates from the corresponding metric associated with the shopping cart interaction events when the price is greater than N times the average price the items returned.

8. The method of claim 1, wherein the metric comprises a price of an item that is subject of the shopping cart interaction event and the corresponding metric comprises an average price of a category of items corresponding to the item and returned by previous user interaction events made by the user in the electronic shopping interactive computing environment.

9. The method of claim 1, wherein the prompt is presented only when the electronic shopping interactive computing environment has a predefined return policy for an item that is subject of the shopping cart interaction event.

10. The method of claim 1, wherein the metric comprises a price of an item that is subject of the shopping cart interaction event and the corresponding metric comprises an average price of a category of items corresponding to the item that are available in the electronic shopping interactive computing environment.

11. The method of claim 1, wherein the metric comprises a price of an item that is subject of the shopping cart interaction event and the corresponding metric comprises a scaled average price of a category of items corresponding to the item that are available in the electronic shopping interactive computing environment.

12. An electronic device, comprising:
a user interface;
a memory; and
one or more processors operable with the user interface and the memory;
wherein:
in response to the one or more processors detecting an item selection by a shopping cart interaction event made by a user in an interactive shopping session in an electronic shopping application operating on the one or more processors, the one or more processors compare a price of the item with at least a first metric associated with past purchases made by the user in the electronic shopping application and at least a second metric associated with past returns made by the user in the electronic shopping application; and
when either the price exceeds the first metric by a predefined threshold or the price exceeds the second metric by a predefined threshold, the one or more processors preclude product return user interaction events from occurring in the electronic shopping application.

13. The electronic device of claim 12, wherein when either the price exceeds the first metric by the predefined threshold or the price exceeds the second metric by the predefined threshold, the one or more processors preclude shopping cart completion user interaction events for the item.

14. The electronic device of claim 13, wherein the one or more processors further terminate the interactive shopping session.

15. The electronic device of claim 12, wherein the one or more processors further cause the user interface to present a prompt indicating that the product return user interaction events have been precluded from occurring in the electronic shopping application.

16. The electronic device of claim 15, wherein the first metric comprises an average price of a category of items corresponding to the item and purchased by previous shopping cart interaction events made by the user in the electronic shopping interactive computing environment.

17. The electronic device of claim 16, wherein the second metric comprises another average price of the category of items corresponding to the item and returned by previous user interaction events made by the user in the electronic shopping interactive computing environment.

18. A method in an electronic device, the method comprising:
in response to user input from a user initiating a shopping cart interaction event in an electronic shopping interactive computing environment operating on one or more processors of the electronic device, comparing, by the one or more processors a price of an item that is subject of the shopping cart interaction event to:
a first summary price of products ordered by the user, both overall and per a category associated with the item;
a second summary price of products returned by the user, both overall and per the category; and
a third summary price of products available in the electronic shopping interactive computing environment, both overall and per the category; and
where the price exceeds any of the first summary price, the second summary price, or the third summary price, precluding product return user interaction events for the item from occurring in the electronic shopping interactive computing environment.

19. The method of claim 18, further comprising presenting, by the one or more processors, a prompt on a user interface of the electronic device indicating that any additional shopping cart interaction events will be unavailable for product return user interaction events in the electronic shopping interactive computing environment.

20. The method of claim 18, wherein the first summary price, the second summary price, and the third summary price comprise median prices.
